(19) United States
(12) Patent Application Publication
(10) Pub. No.: US 2010/0034075 A1
(43) Pub. Date: Feb. 11, 2010

(54) OPTICAL DISC WITH POSTPONED VIEWING WINDOW

(75) Inventors: Ronald Joseph Antonius Van Den Oetelaar, Eindhoven (NL); Donato Pasquariello, Vaesteras (SE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/444,702

(22) PCT Filed: Oct. 4, 2007
(86) PCT No.: PCT/IB07/54043

§ 371 Date: Apr. 8, 2009

(30) Foreign Application Priority Data
Oct. 10, 2006 (EP) 06122030.7

(51) Int. Cl. G11B 3/70

(52) U.S. Cl. 369/283; G9B/3.103

(57) ABSTRACT

An optical storage medium comprising a data layer suitable to be read by means of a radiation beam in an optical scanning apparatus, and access control means for inhibiting reading of at least part of stored information for a predetermined period of time, thereby leading to a postponed viewing window. Preferably the access control means correspond to an access control layer covering at least part of the data layer, chosen to inhibit access to the data layer. The onset of the predetermined period of time may be determined by exposure of the access control layer to an activating substance. A diffusion barrier layer may control the length of the predetermined period of time. Such optical storage medium is preferably used for distributing content having a fixed release date.

### FIELD OF THE INVENTION

The present invention relates generally to an optical storage medium and use of such an optical storage medium for distributing content. The application also relates to a method for controlling access to at least part of information stored in a data layer of an optical storage medium and a method of distributing content.

### BACKGROUND OF THE INVENTION

Use of optical storage media for distribution, for example via direct sales or rental, of entertainment content, such as video content, music, games or software, is well known. Content owners, such as movie studios and game developers, aim to release certain content such as a movie title at the same date in an entire market region. In case of a popular release with a high volume of media, a lot of stress is put on the distribution system, since a large amount of optical storage media must be distributed in a short time span, with negative impact on the total distribution costs.

In the same time, customers may prefer to acquire certain content such as a movie or a game at the release date, but may not be able to purchase the medium at the release date, due to conflicts with their personal time schedules.

### SUMMARY OF THE INVENTION

It is an object of the invention to improve the flexibility in distributing content while maintaining a single release date for certain content in an entire market region. The object of the invention is reached by use of an optical storage medium as claimed in claim 1. Such an optical storage medium comprises a data layer wherein information is stored, the data layer suitable to be read by means of a radiation beam in an optical scanning apparatus and access control means for inhibiting reading of at least part of the stored information for a predetermined period of time. Consequently, when content, which, in a known method, would have been distributed starting with a given release date, is now stored and distributed on optical storage media as claimed in claim 1, the optical storage media can be distributed by the content owner over the predetermined period of time before the release date. As distribution of the media can start before the release date, this may lead to improved balance in income profile and allocation of resources for stores. Furthermore, it may allow customers to purchase the media according to their preferred time schedules.

It is noted that throughout this application, the word “content” is used to describe any intellectual creation that is copyrighted and that a copyright owner intends to distribute in certain markets, by itself or via third parties. It is assumed to comprise any of the following or combination thereof: video content, such as movies, audio content, such as music and audio books, games and/or software. It is further noted that, throughout this application, the word “distribution” is used to describe any means or methods of making content available to third parties, for example by means of direct sale, rental or licensing.

Advantageously, the access control means comprise an access control layer chosen to inhibit reading of the stored information by means of the radiation beam, the access control layer covering at least part of the data layer. A possible solution to control the viewing window of optical storage media involves use of suitable Digital Rights Management (DRM) methods. Typically, the rights of a user are obtained by means of interaction between an optical drive and media, and it may require a suitably adapted optical drive and connection to the Internet. This is disadvantageous, it limits the size of the distribution market by firstly, lack of compatibility with standard players by requiring a suitably adapted drive and secondly, as access to the Internet may not always be available. Use of an access control layer chosen to inhibit reading of the stored information by means of the radiation beam, the access control layer covering at least part of the data layer alleviates such problems, as the compatibility with standard players is maintained and access to internet is not required.

In an embodiment of the invention, the predetermined period of time is measured from an exposure of the access control layer to an activating substance, the exposure enabling a change in an optical property of the access control layer. Such a solution is advantageous as it enables the disc manufacture date to be independent from the desired release date.

In an embodiment of the invention, the change in the optical properties of the access control layer is a change in the absorption of the radiation used for readout of the stored information. By properly tuning such change, the access layer may change from an opaque layer to a transparent layer.

When the optical storage media is of the DVD type, thymolphthalein may be used to advantage in such layer. Thymolphthalein is blue, therefore absorbing in the red part of the spectrum used in reading DVD disc. When mixed into a basic solution that becomes more acidic upon exposure to oxygen or water, this cause the color to change from blue to colorless, consequently enabling readout of the DVD disc.

In an advantageous embodiment of the invention, the optical storage medium further comprises a diffusion barrier layer covering the access control layer. Preferably, the diffusion control layer comprises silicon nitride or silicon dioxide or combination thereof. The thickness of the diffusion barrier layer can be used to set the length of the predetermined period of time. The diffusion barrier layer may be arranged to cover at least a portion of a topside and/or at least a portion of an underside of the reactive layer and the access control layer further comprises additives.

According to a further aspect of the invention there is provided a method for controlling access to at least part of information stored in a data layer of an optical storage medium, comprising steps of providing an access control layer covering at least part of the data layer, the access control layer chosen to inhibiting readout of said at least part of the stored information and exposing the access control layer to a predetermined substance, for enabling changing the optical properties of the access control layer so that readout of the stored information is enabled after a predetermined period of time from exposure. It shall be understood that the method may have features corresponding to the features defined in the dependent claims for the optical storage medium.

According to a further aspect of the invention there is provided a method of distributing content comprising storing the content in a data layer of a first optical storage media according to the invention, exposing the access control layer of said first optical storage media to the activating substance for enabling access to said stored content after a first period of time and distributing said optical storage media before end of said first period of time. Consequently, the optical storage media can be distributed over the predetermined period of time before the release date. As distribution of the media can start before the release date, this may lead to improved balance in income profile and allocation of resources for stores. Furthermore, it may allow customers to purchase the media according to their preferred time schedules.

An advantageous aspect of the method of distributing content is obtained when only part of the data is covered by the access control layer, a first part of the content being stored in the part of the data layer not covered by the access control layer. Customers may prefer to have access to special content features, such as movie teasers or game exercises, before the release date. Such special content features may be provided in the part of the data layer not covered by the access control layer, which is therefore accessible before the end of the predetermined period.

According to a further aspect of the invention, a method for distributing content further comprises storing the content in a data layer of a second optical storage media according to the invention, the second optical storage media being chosen such that a corresponding second period of time being different from the first period of time, exposing the access control layer of said second optical storage media to the activating substance substantially simultaneous to exposing the access control layer of said first optical storage media and distributing said second optical storage media before end of said second period of time. Therefore, if optical storage media having different period of time before onset of readability are distributed in different market regions, each market region may be assigned a different release date, independent of the media production date.

These and other aspects of the invention are apparent from and will be elucidated with reference to following more particular description of several embodiments described hereinafter.

### BRIEF DESCRIPTION OF THE DRAWINGS

The features and advantages of the invention will be appreciated upon reference to the following drawings, in which:

FIG. 1 illustrates a conventional optical storage medium;

FIG. 2 illustrates a cross section through an optical storage medium according to an aspect of the invention;

FIG. 3 illustrates a cross section through an optical storage medium according to another aspect of the present invention.

FIG. 4 illustrates an optical storage medium according to another aspect of the present invention.

FIG. 5 illustrates a method of distributing entertainment content according to an aspect of the present invention.

FIG. 6 illustrates the chemical formulas of thymolphthalein (FIG. 6a), Congo red (FIG. 6b) and viologen (FIG. 6c).

FIG. 7 shows the molecule and absorption spectrum of Basic Blue.

FIG. 8 shows the molecule and absorption spectrum of Nile Blue.

### DETAILED DESCRIPTION OF THE PREFERRED EMBODIMENTS

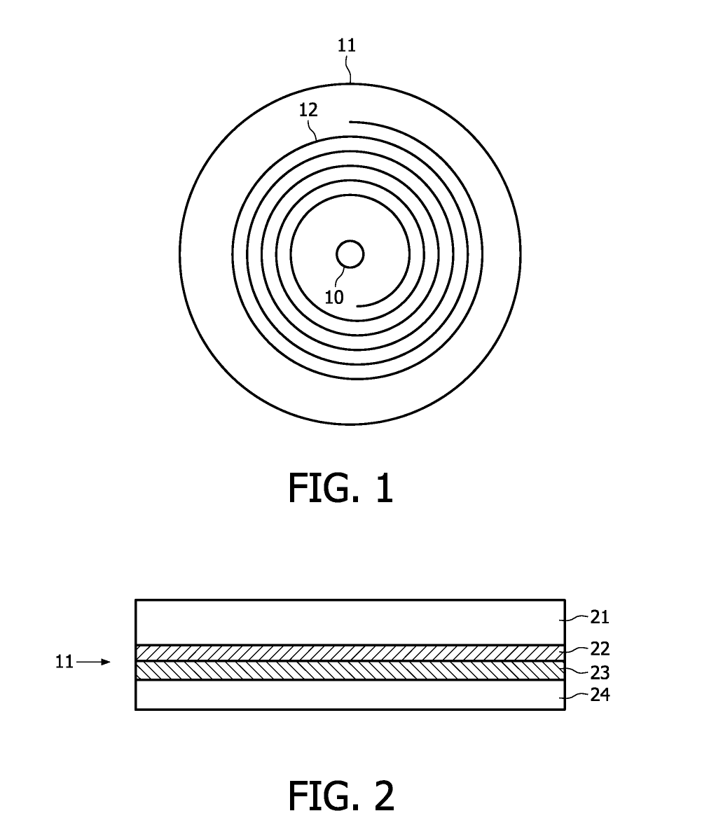

FIG. 1 shows a conventional optical storage medium 11 having a track 12 and a central hole 10. The track 12, being the position of the series of (to be) recorded marks representing information, is arranged in accordance with a single spiral pattern constituting substantially parallel tracks on a data layer. Known examples of optical storage media suitable for distribution of content are CD-ROM, known from ECMA-130 or DVD-ROM, known from ECMA-267 (also known as ISO IEC 16449). The track structure is constituted, for example, by a pregroove, which enables a read/write head to follow the track during scanning. The track structure comprises position information, e.g. addresses, for indication of the location of units of information, usually called information blocks. The position information includes specific synchronizing marks for locating the start of such information blocks. The position information is encoded in frames of modulated wobbles.

If viewed in cross-section, an optical storage medium usually comprises a transparent substrate, the data layer and a protective layer. For example, in DVD systems, the data layer is at a 0.6 mm substrate and a further substrate of 0.6 mm is bonded to the backside thereof. The pregroove 14 may be implemented as an indentation or elevation of the substrate material, or as a material property deviating form its surroundings.

The optical storage medium 11 is intended for carrying real-time information according to a standardized format, to be playable on standardized playback devices. The recording format includes the way information is recorded, encoded and logically mapped. The logical mapping may comprise a subdivision of the available area in a lead-in, a recording area for user data and a lead-out. Further, the mapping may comprise file management information for retrieving the user information, such as a Table of Contents or a file system, e.g. ISO 9660 for CD-ROM or UDF for DVD-ROM or high-density optical media such as Blu-ray Disc (BD). Such file management information is mapped on a predefined location on the record carrier, usually in or directly after the lead-in area. However, this document does not relate to the application format, but to the physical structure of such optical storage medium.

Content owners, such as movie studios and game developers, aim to release their content at the same date, known as the release date, in an entire market region. In case of a popular release with a high volume of optical media to be distributed, a lot of stress (and related cost) is put on the distribution system, since a large amount of media must be distributed in a short time span. In addition, price levels tend to drop rather quickly after the release date, thus reducing the margins for the content owners. Moreover, customers may prefer to watch a movie or play a game at the release date, but may not be able to purchase the DVD at the release date, due to conflicts with their personal time schedules.

In order to address some of the above, according to the invention, standard optical storage media for distribution of content are replaced with optical storage media with a postponed viewing window, wherein the release date is set by the start of the viewing window.

FIG. 2 illustrates a cross section through an optical storage medium according to an aspect of the invention. The optical storage medium comprises a stack of layers, including a substrate 21, a data layer 22, wherein the information may be stored, an access control layer 23 and a cover layer 24.

With respect to the access control layer 23, it is chosen such that it has two states, an initial state that blocks readout of the data layer and a final state that allows access to the data layer. The layer is further chosen such that a transition from the initial state to the final state takes place after a predetermined period from an activation event. Several embodiments for the access layer having the above-mentioned properties are possible.

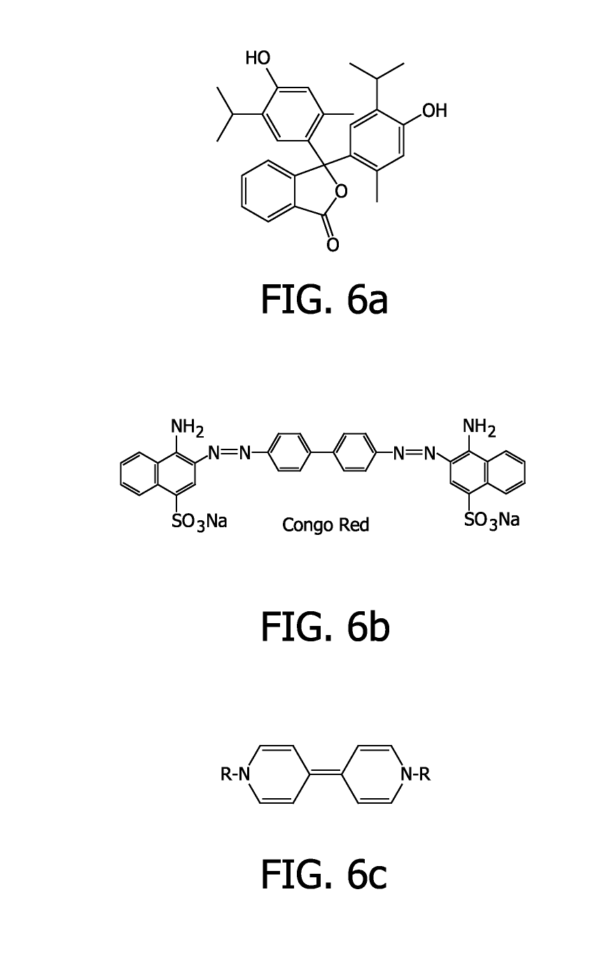

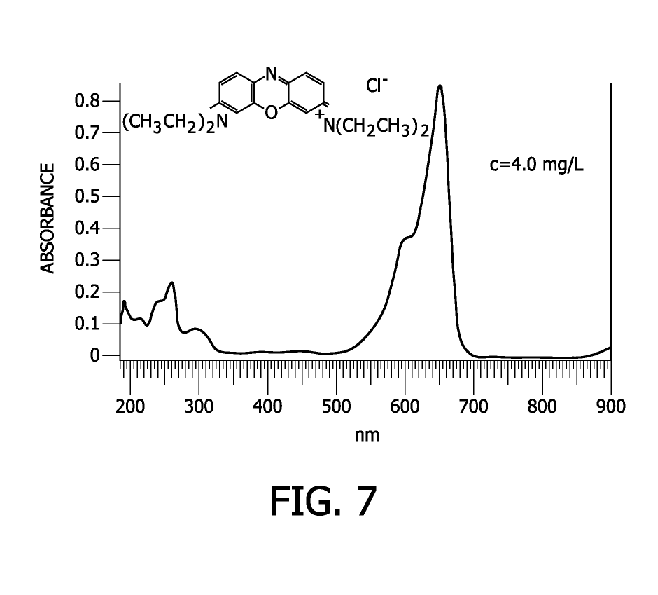

In an embodiment, the absorptive properties are used: the access control layer comprises a dye or indicator that in an initial state provides a high absorption in wavelength range corresponding to that of the radiation used for readout. For example, in case of red lasers used for reading and recording DVDs, the dye or indicator absorb red light in the initial state. Further, the dye or indicator is chosen such that when exposed to a suitable reagent, it suffers a transition to a final state, for example an oxidized state when the reagent is oxygen or water. The dye or reagent is chosen to be transparent in the final state in a wavelength range corresponding to that of the radiation used for readout. Specific examples will be described later with respect to FIGS. 6-7. Furthermore, other mechanisms and/or materials may be used to change the access control layer from an “absorption state” to a “transparent state”, e.g. mechanisms based on oxidation or water penetration upon exposure of the optical medium to air.

In an alternative embodiment, other optical properties of the access control layer, such as changes in the index of refraction are used. In an initial state, the index of refraction is chosen such that it inhibits focusing of the radiation beam onto the data layer, thereby preventing reading the information. In a final state, the index of refraction substantially matches the index of refraction of the cover layer, thereby enabling focusing of the radiation beam. Specifically, this may be implementing by means of using a solution of a polymer and a solvent. The polymer is chosen such that its index of refraction substantially matched that of the cover layer and/or substrate, while that of the solvent not. The solvent is chosen such that it will sublimate and/or evaporate over a predetermined period.

In another embodiment of a disc according to the invention, the access control layer 23 is a thin metallic layer, for example a 15 nm thick silver (Ag) layer. Readout access to the data layer 22 depends on the oxidation state of the metal layer. It is known that metallic layers provide a high absorption in the spectral range used for readout of optical discs, while most metallic oxides are transparent insulators.

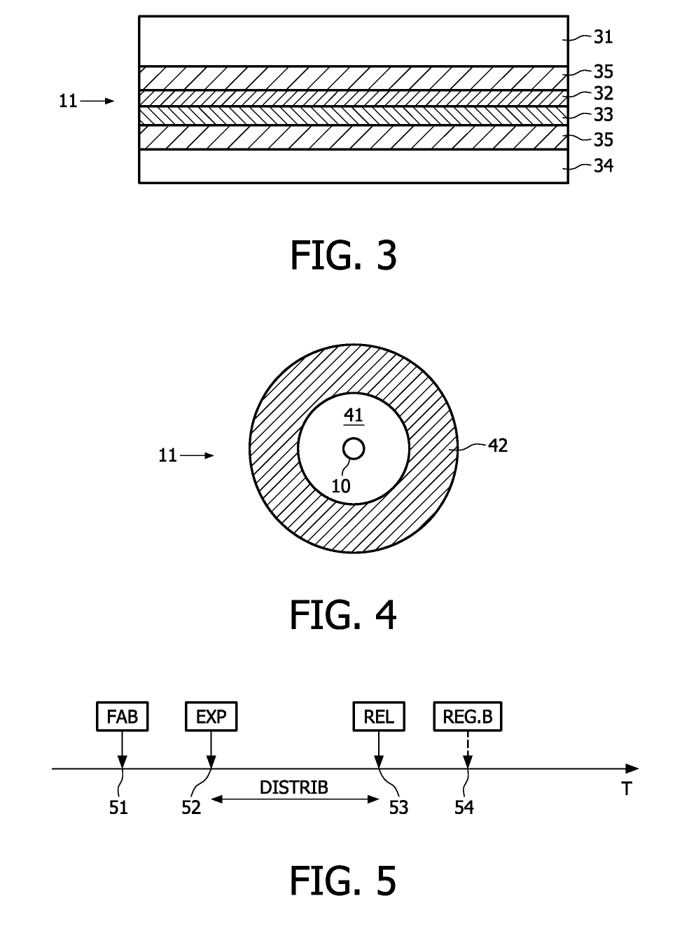

The control of the predetermined period may be implemented, by means of controlling the rate at which the reagent comes in contact with the access control layer 23, for example by controlling the porosity of the substrate. An alternative method of controlling the predetermined period, based on use of a diffusion layer will be described with reference to FIG. 3.

FIG. 3 illustrates a cross section through an optical storage medium according to another aspect of the present invention.

The optical storage medium comprises a stack of layers, including a substrate 31, a data layer 32, wherein the information may be stored, an access control layer 33 and a cover layer 34. In addition, according to this aspect of the invention, there is provided a diffusion layer 35. The diffusion layer 35 acts as a barrier, and it can be configured to tune the period before the transition to the final state of the access control layer 33. For example, the diffusion layer 35 can be a silicon-nitride layer for limiting the oxygen diffusion or water diffusion from penetrating the access control layer 33. Furthermore, in addition to having a diffusion layer 35 covering the “topside” of the access control layer 33, a second diffusion layer 35b may also be provided for limiting reagent (such as oxygen or water) diffusion penetrating the access control layer 33 from the “underside”. It will be appreciated that other possibilities are covered by the invention, such as the provision of the second diffusion layer 35b without a diffusion layer 35, or in which each diffusion layer only covers part of the access control layer 33. With the latter, it is possible that one portion of the data layer 32 is inaccessible prior to the transition to the final state.

The diffusion layers 35 and/or 35b act to limit the oxygen or moisture diffusion from air to control layer 33, and thereby limit the oxygen diffusion. According to one embodiment, the predetermined period is controlled by varying the thickness of the diffusion layer 35b and/or 35. It is known that diffusion time through a material is in general inversely proportional to the square of the thickness of such layer. In other words, the thickness of the diffusion layer 35b and/or 35 controls the amount of reagent, such as oxygen or moisture that reaches the access control layer 33. Alternatively, the predetermined period can also be tuned by varying the amount of reactive additives in the adhesive layer.

Although the embodiment above has been described as having separate diffusion layers 35b and/or 35, it is noted that the diffusion layers 35b and/or 35 may form part of the substrates 31 and/or cover layer 34, respectively. In other words, according to this particular embodiment, the transition is controlled by controlling the diffusion of oxygen or moisture through the disc by tuning the porosity of the substrate 31. In this manner, the predetermined period can be controlled during manufacturing. In other words, once manufactured with a particular diffusion layer 35b and/or 35, there is a predetermined period from exposure to a suitable reagent, such as oxygen or water, before the recorded information may be accessed.

It will be appreciated that the invention also embraces other methods of tuning the predetermined period before reading the data layer is enabled. For example, spin-coated lacquer layers can be applied to a disc at any interface, even on the surface of the disc. Lacquer layers (for example spin-coated UV curable resin) are often used in optical disc production as an adhesive or as an oxygen and moisture diffusion barrier.

It is also noted that while the preferred embodiments show a preferred layout for the various layers in the optical disc, these layers may be interchanged or arranged differently as appropriate. For example, although the diffusion barrier layers 35b is being shown as placed on the underside of the data layer 32, it may be equally arranged directly next to the underside of the access control layer 33, since this would still limit oxygen or moisture from reaching the access control layer 33. In a similar manner, the diffusion barrier layer 35 could also be located elsewhere to the topside of the access control layer 33. It will be appreciated that the term “topside” means the side that is located towards the laser source, whereas the term “underside” means the side located away from the laser source.

FIG. 4 illustrates an optical storage medium according to another aspect of the present invention. Region 42 comprises stored information, such as a main feature in a movie, that is protected by an access control layer as described with reference to FIG. 2 or 3. Region 41 comprises further information, such as special content features, and its structure correspond to a normal optical medium, that is the information stored therein is directly accessible. Said regions are shown as annular regions around the hole 10, with Region 42 shown towards the outside. Such a physical arrangement provides the advantage of compatibility with standard player devices, which expect the lead-in region to be located at the inner part of a track. However, different arrangements are possible.

It is noted that by providing access to special content features (such as movie trailers, teasers or other extras) directly after purchase of the optical storage medium, the entertainment value for the customer is enhanced and spread over a longer time span. In case of game distribution, the special content features may consist of exercise material allowing customers to improve—in advance—their basic skills in playing the game. The presence of such special content features clearly provides incentives to the customer to purchase the optical medium before the release date. Furthermore, the presence of early accessible special features extends the “freshness” and “hype” of the content over a longer period of time.

According to another aspect of the invention, the number of disc areas having a different release date (the moment after the predetermined period when the content becomes readable) is extended to several, thereby obtaining an optical disc provided with a periodically postponed viewing window.

Several embodiments of this aspect of the invention are possible. In a first embodiment, the optical disc comprises several disc areas, preferably corresponding to annular regions, each area having a different release date; the release dates being for example spaced at regular time intervals. The different release date may be provided, for example, by using different thicknesses of the diffusion barrier layer 35 in the different disc areas.

In a second embodiment, the optical disc comprises two information layers, on both sides of the disc, corresponding to a so called double sided disc; while each side of the disc corresponds to the top layer of the embodiment described with respect to FIG. 4. It is noted that a layer blocking the diffusion of the reagent between the topside and the underside may be included in this embodiment.

In a third embodiment, a package comprising several optical discs, usually known as a box set of discs, is provided, each disc within the box set having a different release date.

Optical discs provided with a periodically postponed viewing window can be used for offering the user a similar viewing experience to that of a weekly TV series, in particular in the case of a first-run (i.e. never been televised before) series. A periodically postponed viewing window allows for synchronization of periodic content availability, and can stimulate widespread discussions of the content e.g. via Internet forums.

FIG. 5 illustrates a method of distributing entertainment content according to an aspect of the present invention. FIG. 5 illustrated a time line T for the production and distribution of content via optical storage media according to the invention.

At an initial moment 51 (FAB) the optical storage media are fabricated. At a later moment 52 (EXP), the access control layer is exposed to the corresponding reagent, initiating the start of the predetermined period after which the optical storage media will become playable. The moment when the predetermined period ends correspond to the release date 53 (REL). It is noted that the moment 51 and 52 may coincide. The content owner controls the release date by controlling either the length of the predetermined period, e.g. by means of changing the thickness of a diffusion barrier layer or by controlling the exposure moment 52. The period between the exposure moment 52 and the release date 53 is used for media distribution, e.g. by direct sales. In this way, each market region may be assigned a different release date, independent of the media production date. It is noted that in an embodiment of the method, it is possible to produce optical storage media having a different release date 54. In this way, different market region may be assigned a different release date, independent of the media production date.

The model provides significantly greater distribution flexibility: optical media can be distributed by the content owner over a longer time span. Sales of the media can start before the release date, improving the balance in income profile and allocation of resources for stores, and allowing customers to purchase the media according to their preferred time schedules.

An alternative method of distributing content is obtained when a series of discs is produced at the initial moment 51 (FAB), the release dates of the discs in the series preferably forming a periodic time series, for example each disc in the series opening after a week. The series of discs is distributed before the release date of the first disc in the series. This corresponds to mimicking for the end user the experience of a first-run TV series, where each disc in the disc series corresponding to one episode in the TV series is made available every week. Moreover, if the series is successful, it allows easy catch up for end-users who did not follow the series from the beginning. When an end-user acquires the content at a moment when the release date of several discs in the series is passed, (s)he has access to all open episodes, therefore (s)he easily catches up with other users. The fact the new end-user may catch up easily with the previously released content may raise the peak value of each release in the series.

Moreover, in view of the fact that episodes that are at any moment available remain available, the series of disc will have a tangible collector's value when all the episodes in the series are released.

In an alternative embodiment of the method, the distributed content may be reinforced with magazines. For examples monthly magazines may be sold with additional support content provided on optical media according to the invention, new support content being released weekly for example.

Another type of known optical disc is the “limited lifetime” or “limited use” disc. An example of such a disc is the “ez-D” disc, known for example from U.S. Pat. No. 6,790,501. An ez-D disc is supplied in a vacuum-sealed package, and when the package is opened the content on the disc can only be played for a limited time. The “limited use” disc provides a limited lifetime or limited use disc, which is achieved by superimposing the data layer with a layer that darkens after a period when in contact with air.

It is noted that such “limited lifetime” feature may be combined with a disc according the invention, thereby obtaining a disc comprising a postponed limited window. Such feature may be useful in providing change of content. For example, released content is usually provided with additional advertisement content. Having postponed limited window offers the possibility that the advertisement content may change overtime, allowing a more flexible advertisement model.

It is noted the above-described methods may be extended by replacing optical storage media comprising an access control layer with standard optical storage media making use of digital rights management for setting a release date. However the use of digital right management requires being able to establish a present date, for example by means of accessing the internet and may require further resources and may not be compatible with standard playback devices. Use of media according to the invention neither depends on the firmware of the playback device, nor does it require access to the Internet. The start of the viewing window is controlled by changing the optical medium from an unreadable to a readable state at a pre-set time.

In the following some materials shall be explained which can be used according to the present invention to provide the effect of changing its optical reflectivity and/or transmittance over time, i.e. which can be used for the access control layer according to the present invention. In particular, dyes or indicators shall be mentioned that are either blue (high absorption in the range of 600-700 nm) or red, but gradually turn either colorless or change color from red to blue or from blue to red upon oxidation. A dye or indicator having a high absorption in the range of 600-700 nm is suitable for use when the optical storage media require a red laser for reading, such as DVD and CD media. A dye or indicator having a high absorption in the blue range is suitable for use when the optical storage media require a blue laser for reading, such as high-density discs such as Blu-ray Disc (BD) or HD-DVD.

For said purpose, particularly, oxazines (containing a N and an O atom in the second ring) and thiazines (containing a N and a S atom in the second ring) are suitable. In the following, a few examples thereof shall be briefly explained.

With respect to dyes compatible for use with media requiring red lasers for readout (e.g. CD and DVD type media), a first example is thymolphthalein. Thymolphthalein is a blue indicator when mixed into a basic solution and colorless in a neutral or acidic solution. The transition pH range is 9.3-10.5. Exposure to the oxygen or water from air causes a color change from blue to colorless. As long as the indicator in the access control layer is in the blue state, the red laser light from the DVD drive is absorbed and the media remains unreadable. The media becomes readable once the adhesive layer has changed into a state that is transparent for the red laser light.

A second example is Congo red, the sodium salt of benzidinediazo-bis-1-naphtylamine-4-sulfonic acid, having a transition pH range (base—second transition): 3.0-5.2. The initial state at low pH is blue (i.e. absorbing the red laser light), while the final state at high pH (equilibrium) is red.

A third example is viologen, a class corresponding to diquaternary derivatives of 4,4′-bipyridyl. For viologen, the change in absorption spectrum is induced by an oxidation reaction. The initial reduced state is blue, while the final oxidized state is colorless (i.e. transparent for red).

FIG. 6 illustrates the chemical formulas of thymolphthalein (FIG. 6a), Congo red (FIG. 6b) and viologen (FIG. 6c).

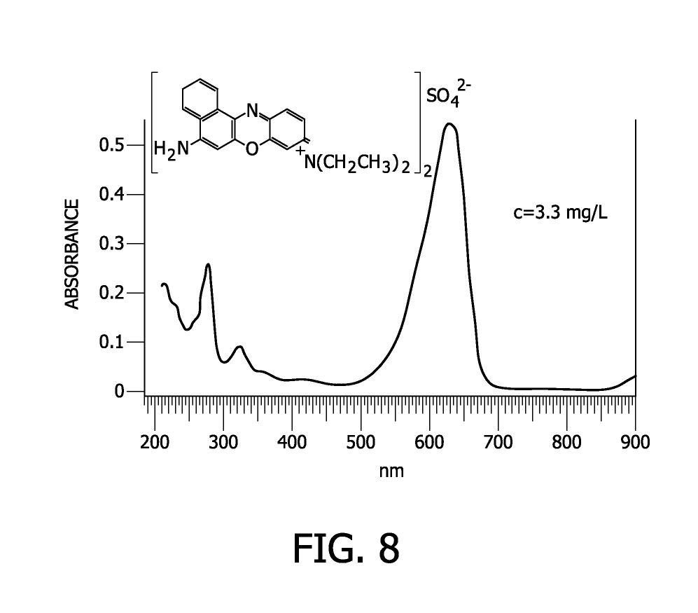

With respect to dyes compatible for use with BD type media, a first example is Basic Blue, whose molecule and absorption spectrum are shown in FIG. 7. The molecule is likely to be susceptible to oxidative de-ethylation with the concomitant formation of polychromatic end products. A second example is Nile Blue, whose molecule and absorption spectrum are shown in FIG. 8. It is known that in a solution of water Nile Blue gradually transforms in Nile Red: the NH₂-group is replaced by ═O. The absorption peak shifts from 650 nm to 550 nm. This also occurs when water is diffusing through the polycarbonate substrate to the dye layer, so that this molecule is a candidate for the aimed application.

More details about such materials can be found in The Sigma-Aldrich Handbook of Stains, Dyes and Indicators, F. J. Green, Aldrich Chemical Company, Milwaukee, Wis. (1990).

Another useful approach is to use so-called invisible ink. There are various kinds, the most useful ones are blue, red or black directly after writing, but fade away in about two days (due to an oxidation reaction). For instance, such invisible inks are described at http://www.pimall.com/nais/dispen.html.

The embodiments described above can be extended to other optical storage systems that use a different laser beam wavelength, by choosing an acid-base indicator with a different initial color (having a suitable absorption spectrum for the specific wavelength).

The present invention can be summarized as follows: An optical storage medium comprising a data layer suitable to be read by means of a radiation beam in an optical scanning apparatus, and access control means for inhibiting reading of at least part of stored information for a predetermined period of time, thereby leading to a postponed viewing window. Preferably the access control means correspond to an access control layer covering at least part of the data layer, chosen to inhibit access to the data layer. The onset of the predetermined period of time may be determined by exposure of the access control layer to an activating substance. A diffusion barrier layer may control the length of the predetermined period of time. Such optical storage medium is preferably used for distributing content having a fixed release date.

It should be noted that the above-mentioned embodiments are meant to illustrate rather than limit the invention. And that those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The mere fact that certain measures are recited in mutually different dependent claims does not indicate that a combination of these measures cannot be used to advantage.

1. An optical storage medium comprising:
a data layer wherein information is stored, the data layer suitable to be read by means of a radiation beam in an optical scanning apparatus;
wherein the optical storage medium further comprises:
access control means for inhibiting reading of at least part of the stored information for a predetermined period of time.

2. An optical storage medium according to claim 1, characterized in that the access control means comprise an access control layer chosen to inhibit reading of the stored information, the access control layer covering at least part of the data layer.

3. An optical storage medium according to claim 2, characterized in that a begin of the predetermined period of time starts from an exposure of the access control layer to an activating substance, the exposure enabling a change in an optical property of the access control layer.

4. An optical storage medium according to claim 3, characterized in that the change in the optical properties of the access control layer is a change in the absorption of the radiation used for readout of the stored information;

5. An optical storage medium according to claim 4, characterized in that the access control layer comprises any of the following: thymolphthalein, Congo red, viologen, Nile blue, Basic blue.

6. An optical storage medium according claim 2, characterized in that the optical storage medium further comprises a diffusion barrier layer covering the access control layer.

7. An optical storage medium according to claim 6, characterized in that the diffusion control layer comprises silicon nitride or silicon dioxide or combination thereof.

8. An optical storage medium according to claim 6, characterized in that said diffusion barrier layer has a predetermined thickness by which a length of the predetermined period of time is set.

9. An optical storage medium according to claim 8, characterized in that wherein the diffusion barrier layer is arranged to cover at least a portion of a topside and/or at least a portion of an underside of the reactive layer.

10. An optical storage medium according to claim 8, characterized in that said at least two access control layers are provided, each access layer covering a corresponding disc area, each access layer having a corresponding predetermined period of time.

11. An optical storage medium according to claim 10, characterized in that a series of access control layers are provided, each access layer covering a corresponding disc area, each access layer having a corresponding predetermined period of time, the predetermined periods of time corresponding to a periodic time series.

12. An optical storage medium according to claim 10, characterized in that a data layer is provided on each side of the disc, each access control layer covering a corresponding data layer.

13. An optical storage medium according to claim 1, characterized in that it further comprises an access limiting layer covering at least part of the data layer, the access limiting layer chosen such to inhibit reading of the stored information in the data layer after a limited period of time.

14. A box comprising a series of optical storage mediums according to claim 1, characterized in that the corresponding predetermined periods of time correspond to a periodic time series.

15. Use of an optical storage medium according to claim 1 for distributing content.

16. Use of an optical storage medium according to claim 1 for distributing supplementary content to a main content distributed by means of paper media.

17. A method for controlling access to at least part of information stored in a data layer of an optical storage medium, comprising steps of:
providing an access control layer covering at least part of the data layer, the access control layer chosen to inhibiting readout of said at least part of the stored information;
exposing the access control layer to a predetermined substance, for enabling changing the optical properties of the access control layer so that readout of the stored information is enabled after a predetermined period of time from exposure.

18. A method according to claim 17, characterized by providing at least two access control layers, each access layer covering a corresponding disc area, each access layer having a corresponding predetermined period of time.

19. A method of distributing content comprising:
storing the content in a data layer of a first optical storage media according to claim 3;
exposing the access control layer of said first optical storage media to the activating substance for enabling access to said stored content after a first period of time;
distributing said optical storage media before end of said first period of time.

20. A method of distributing content comprising:
storing the content in a data layer of a first optical storage media according to claim 3;
exposing the access control layer of said optical storage media to the activating, substance for enabling access to said stored content after a first period of time;
distributing said first optical storage media before end of said first period of time
storing the content in a data layer of a second optical storage media according to claim 3, the second optical storage media being chosen such that a corresponding second period of time being different from the first period of time.
exposing the access control layer of said second optical storage media to the activating substance substantially simultaneous to exposing the access control layer of said first optical storage media;
distributing said second optical storage media before end of said second period of time.

21. A method according to claim 18, characterized by choosing a first optical storage media wherein only part of the data is covered the access control layer, a first part of the content being stored in the part of the data not covered by the access control layer.
